(19) United States
(12) Patent Application Publication
(10) Pub. No.: US 2008/0067035 A1
(43) Pub. Date: Mar. 20, 2008

(54) Automatic pallet changer

(76) Inventors: Malcolm E. Keith, Algonquin, IL (US); Michael Paul Cayley, South Barrington, IL (US)

Correspondence Address: Douglas H. Pauley;Pauley Petersen & Erickson, Suite 365, 2800 West Higgins Road, Hoffman Estates, IL, 60195, US

(21) Appl. No.: 11/514,677

(22) Filed: Sep. 1, 2006

(51) Int. Cl. B65G 47/22

(52) U.S. Cl. 198/345.3

(57) ABSTRACT

An automated pallet changer for detachably attaching a pallet with respect to a machine table or a frame, particularly of a 5-axis machining center. The automated pallet changer can attach and/or detach a pallet with respect to the frame. A keeper element is movable with respect to a base of the receiver, between an engaged position and a disengaged position. In the engaged position, the keeper interferes with a least a portion of the pallet to fix the position of the pallet with respect to the machine table. The automated pallet changer according to this invention can be used to eliminate the need for electrical cables, pneumatic lines, hydraulic lines and the like on a conventional 5-axis machining center.

### BACKGROUND OF THE INVENTION

1. Field of the Invention

This invention relates to an apparatus and method for operating an automated pallet changer, particularly for a 5-axis machining center, wherein pallets are automatically moved and attached or detached with respect to a frame of the machining center.

2. Discussion of Related Art

Conventional machining centers can operate about five axes, the X-axis, the Y-axis, the Z-axis, the A-axis and the C-axis. One or more workpieces are normally attached to the conventional machining center at a machine table, a frame or another structural member that can be rotated about each of the five axes.

With conventional 5-axis machining centers, pallets are normally changed through a manual operation. Many conventional 5-axis machining centers also use or have electrical cables, pneumatic lines, hydraulic lines or other similar mechanical components to rotate the workpiece about the A-axis and the C-axis. Such mechanical components interfere with moving parts and thus limit rotation of the workpiece. Also, such components prohibit an automated device or system for changing pallets, that hold the workpieces, and require manual changeover of the pallet and/or the workpiece.

There is an apparent need for an automated apparatus and method for changing pallets and thus workpieces, to save manufacturing time and costs.

### SUMMARY OF THE INVENTION

It is one object of this invention to provide an automated pallet changer for attaching and detaching a pallet with respect to a machine tool, such as a 5-axis machining center.

It is another object of this invention to provide a method for automatically and/or robotically changing a pallet at a machine table or other frame of a 5-axis machining center.

The above and other objects of this invention are accomplished with a pallet that is detachably attached with respect to a machine table or a frame, such as of a 5-axis machining center. An automatic pallet changer attaches or detaches the pallet with respect to the frame.

A receiver is connected to, attached to, or otherwise fixed with respect to the frame or the machine table of the machining center. The pallet can be engageable with a base of the receiver. In an engaged position, the pallet is locked with respect to the base. In a disengaged position, the pallet is detached or detachable with respect to the base.

A keeper is preferably but not necessarily moveably mounted with respect to the base. In the engaged position, the keeper can interfere with the pallet to prevent the pallet from detaching with respect to the base. In the engaged position, a workpiece fixed with respect to the pallet can be machined and then rotated about any one or more of the five axes.

An activation element, such as a pushrod, can be used to move the keeper between the engaged position and the disengaged position. A robot or other automated device can be used to move and/or operate the activation element, for example as a function of a programmed set of movements or commands.

The automated pallet changer can be moved between the 5-axis machining center and a storage facility, to attach or detach either an active pallet or an inactive pallet.

The automated pallet changer of this invention can be used to eliminate the need for a manual changeover of the pallet and/or the workpiece. The automated pallet changer of this invention can also significantly reduce the time necessary to complete a pallet and/or a workpiece changeover, as well as to increase time and cost efficiencies.

### DESCRIPTION OF THE DRAWINGS

The above and other features and objects of this invention are better understood from the following detailed description taken in view of the drawings, wherein:

FIG. 1 is a plan view of an automated pallet changer, in an engaged or clamped position, according to one embodiment of this invention;

FIG. 2 is a front view of the automated pallet changer, as shown in FIG. 1;

FIG. 3 is a side view of the automated pallet changer, as shown in FIG. 1, but without the pallet and the machine table or frame shown in phantom lines;

FIG. 4 is a plan view of an automated pallet changer, in a disengaged or unclamped position, according to one embodiment of this invention;

FIG. 5 is a front view of the automated pallet changer, as shown in FIG. 4;

FIG. 6 is a side view of the automated pallet changer, as shown in FIG. 4, but without the pallet and the machine table or frame shown by the phantom lines;

FIG. 7 is a plan view of an automated pallet changer, with an engaged or clamped position shown in solid lines and with a disengaged or unclamped position shown in phantom lines, according to one embodiment of this invention;

FIG. 8 is a front view of the automated pallet changer, as shown in FIG. 7;

FIG. 9 is a side view of the automated pallet changer, as shown in FIG. 7;

FIG. 10 is a plan view of a keeper element, according to one embodiment of this invention;

FIG. 11 is a front view of the keeper element, as shown in FIG. 10;

FIG. 12 is a sectional view of the keeper element, taken along line 12-12, as shown in FIG. 10;

FIG. 13 is a schematic view of a method and apparatus for automatically changing pallets, according to one embodiment of this invention;

FIG. 14 is a front view of a pallet delivery mechanism, according to one embodiment of this invention; and

FIG. 15 is a side view of the pallet delivery mechanism, as shown in FIG. 14.

### DESCRIPTION OF PREFERRED EMBODIMENTS

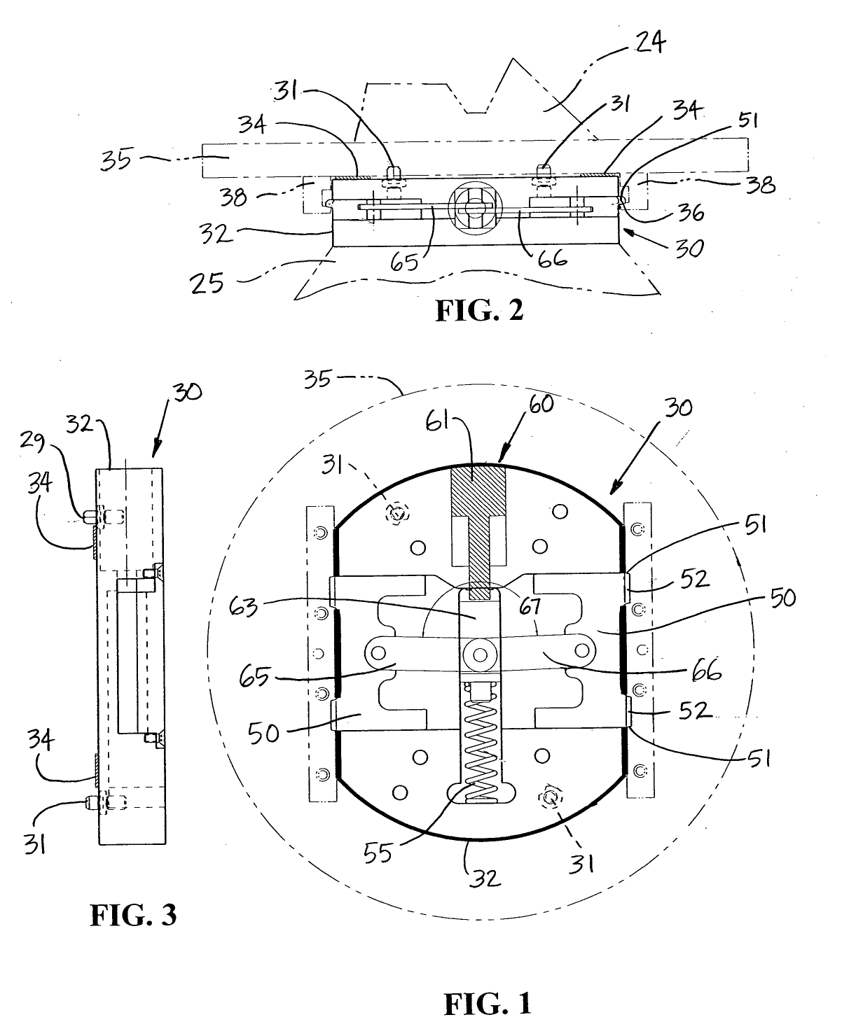

In certain embodiments according to this invention, automated pallet changer 40 comprises receiver 30, such as shown in FIGS. 1-3. In many 5-axis machining centers or machines, frame 25 or another suitable structure, such as a rotatable table, a rotatable machine table and/or a rotatable bed, is attached to or otherwise fixed with respect to a machine that can rotate frame 25 about five different axes, each of the X, Y, Z, A and C axis.

U.S. Pat. No. 6,210,307, issued to Van Horssen, on Apr. 3, 2001, describes background technology associated with conventional 5-axis machining centers, and its entire teachings and the teachings of the references cited therein are incorporated into this specification by reference to U.S. Pat. No. 6,210,307.

FIG. 2 shows workpiece 24, which can have any suitable size and/or shape, attached to, connected to, or otherwise fixed with respect to pallet 35, with any suitable mechanical or structural connection. Workpiece 24 can be positioned or moved about the five different axes. Thus, it is possible to machine or otherwise perform an operation on workpiece 24, for example by moving a spindle or other referred to as vertical machining centers. However, the apparatus and method according to this invention can accommodate a spindle or any other machine tool that operates in any suitable position other than a vertical position.

In certain embodiments of this invention, frame 25 can comprise any structural element and/or device that attaches to, connects to and/or is otherwise fixed with respect to receiver 30 of this invention. Receiver 30 can have a plate shape or any other suitable shape and/or dimensions that accommodate pallet 35 or another similar structural member, such as shown in FIGS. 1 and 2.

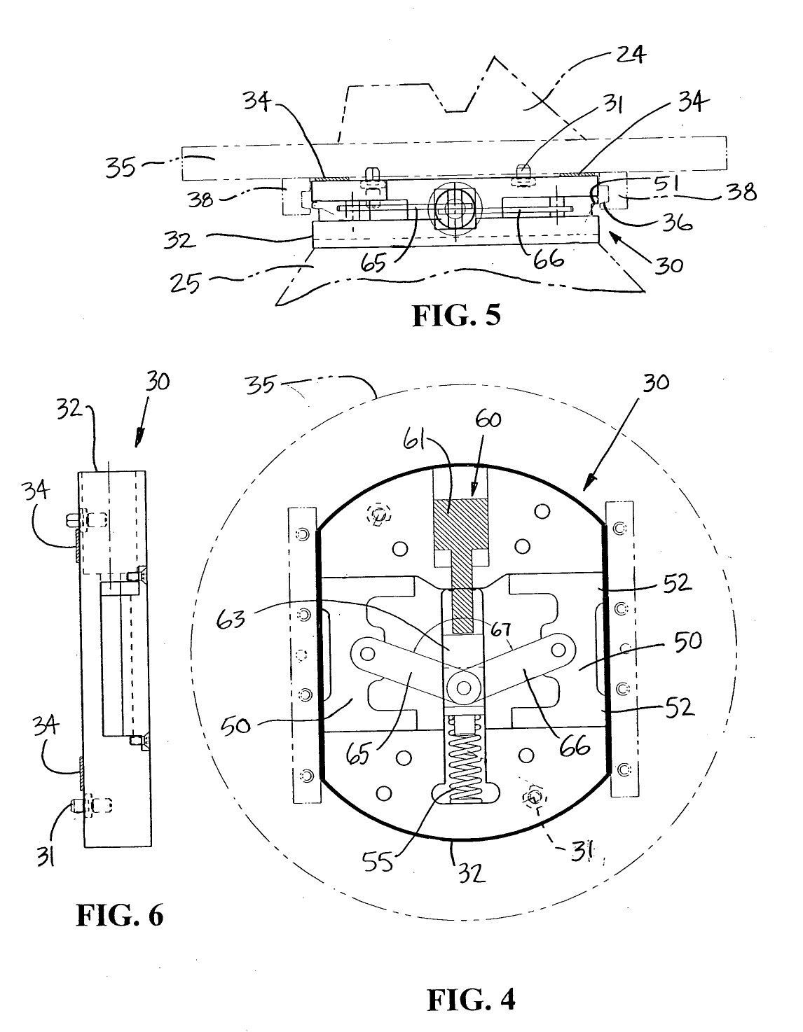

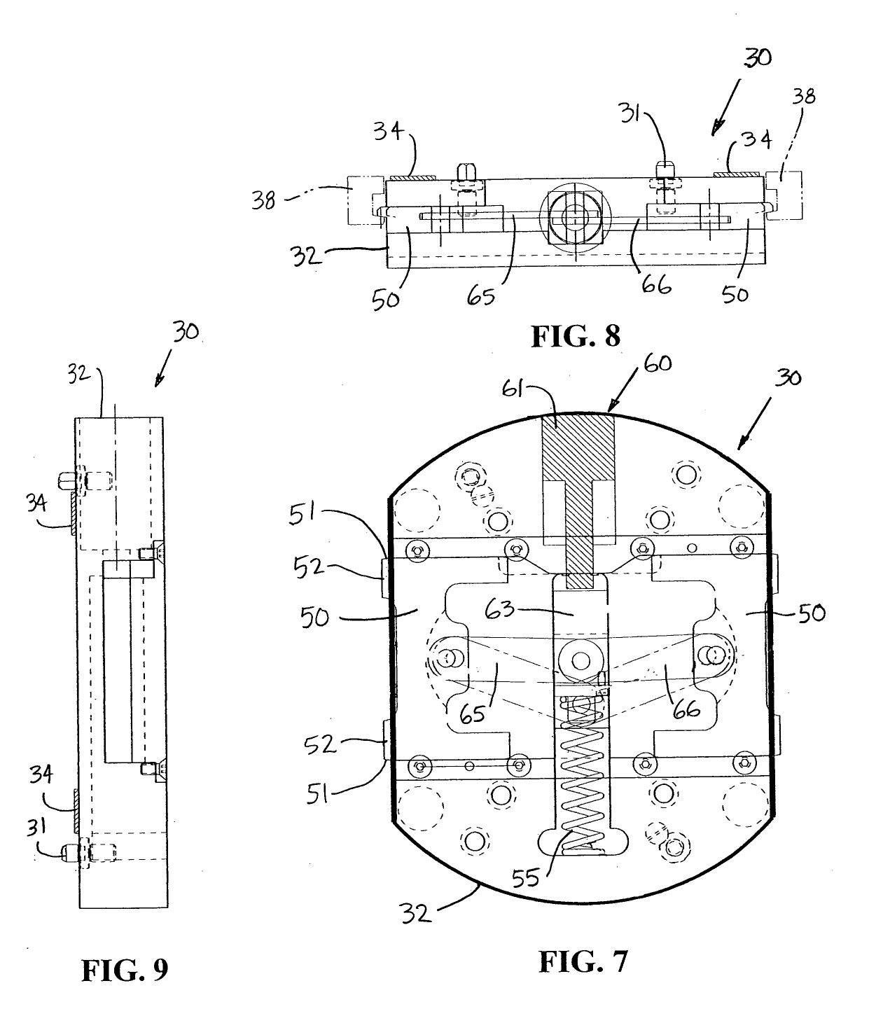

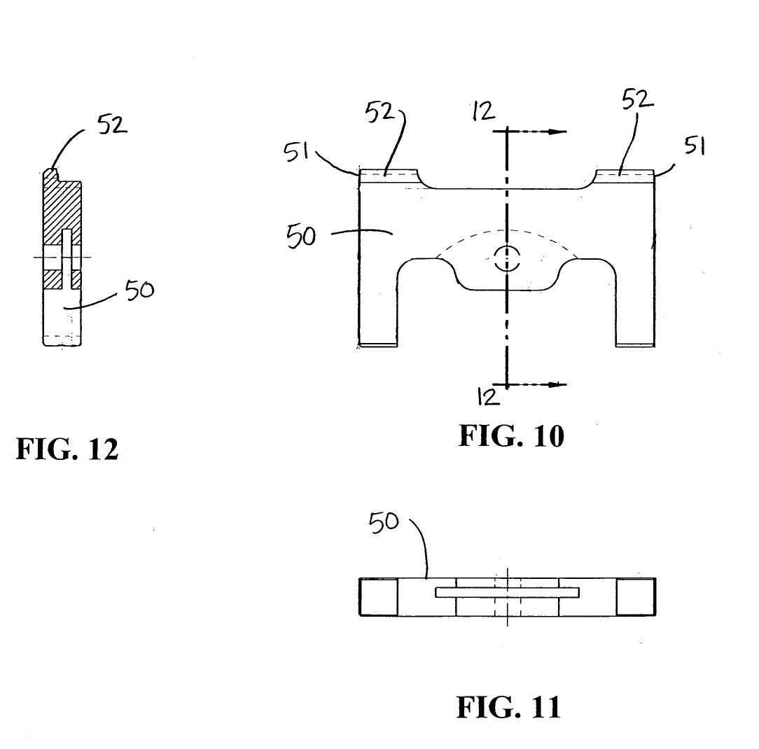

In some embodiments of this invention, pallet 35 is detachably attached with respect to frame 25. FIGS. 1-3 show pallet 35 in an engaged position or a clamped position with respect to base 32 of receiver 30. FIGS. 4-6 show pallet 35 in a disengaged or an unclamped position with respect to base 30. FIGS. 7-9 show pallet 35 both in the engaged position, in solid lines, and in the disengaged position, in phantom lines.

FIGS. 1 and 4 show keeper 50 moveable with respect to base 32. As shown in the engaged position of FIGS. 1 and 2, edge portion 51 of keeper 50 interferes with at least a portion of pallet 35. Keeper 50 can be mounted in a moveable position with respect to receiver 30 using any other suitable mechanical, magnetic and/or electrical device.

FIG. 2 shows two rails 38, each connected to pallet 35. FIG. 1 shows, for example, a fastener used to connect rail 38 to pallet 35. Any suitable mechanical connection or integration, such as by molding, can be used to connect or fix rail 38 with respect to pallet 35.

As shown in FIG. 2, contact portion 36 interferes with edge portion 51, which engages and maintains the position of pallet 35 with respect to receiver 30.

In certain embodiments of this invention, keeper 50 can be moved with respect to base 30, between the engaged position and the disengaged position, to attach and detach, respectively, pallet 35 with respect to receiver 30 and thus with respect to frame 25. In one embodiment according to this invention, keeper 50 can be moved between the engaged position as shown in FIG. 1 and the disengaged position as shown in FIG. 4. Any other suitable mechanical device can be used to accomplish the movement of keeper 50 with respect to receiver 30.

In certain embodiments according to this invention, activation element 60 operates keeper 50 between the engaged position and the disengaged position. As shown in FIGS. 1 and 4, activation element 60 comprises pushrod 61 moveable with respect to base 32, between the engaged position and the disengaged position. In the disengaged position, for example as shown in FIG. 4, pushrod 61 contacts clevis 63 which is moveably mounted with respect to base 32. As shown in FIGS. 1 and 4, clevis 63 is connected to lever arms 65, 66. In certain embodiments of this invention, each of lever arms 65, 66 is pivotally connected at opposing ends to keeper 50 and clevis 63. As shown in FIGS. 1 and 4, angle 67 between arms 65, 66 is less than 1800.

By moving pushrod 61 from the engaged position shown in FIG. 1 to the disengaged position shown in FIG. 4, the length of bias element 55 is changed, such as reduced, thus allowing clevis 63 to move towards bias element 55. Lever arms 65, 66 can be sized and positioned so that moving clevis 63 with respect to body 32 also operates or moves keeper 50 between the engaged position and the disengaged position. Thus, by moving pushrod 61, it is possible to mechanically move keeper 50 with respect to receiver 30.

Pallet 35 is engageable with base 32. As shown in the engaged position of FIGS. 1 and 2, keeper 50 interferes with at least a portion of pallet 35. As shown in the disengaged position of FIGS. 4 and 5, keeper 50 is moved to clear contact or prevent interference with pallet 35. In certain embodiments of this invention, edge portion 51 of keeper 50 extends beyond a surface of base 32, to form the interference engagement with contact surface 36. Any other suitable interference fit and/or mechanical connection can be used to operate pallet 35 between the engaged position and the disengaged position with respect to receiver 30.

As shown in FIGS. 1 and 4, bias element 55 normally urges keeper 50 into the engaged position. Thus, in such embodiments, when activation element 60 is not activated, pallet 35 remains in the engaged position with respect to receiver 30. Any other suitable bias element, such as a spring, a dampener and/or other force-urging member can be used in lieu of or in addition to the spring shown in FIGS. 1 and 4.

As shown in FIGS. 1 and 4, arm 80 can be used to operate activation element 60. In one embodiment according to this invention, arm 80 is mounted with respect to rail 38 which can be moveably mounted to engage with and move pallet 35 with respect to frame 25. Any other suitable mechanical and/or electromechanical device can be used to operate and thus move activation element 60 between the engaged position and the disengaged position. Arm 80, such as shown in FIG. 15, can be a part of robot 85 or a similar robotic device that is controlled to operate activation element 60. Arm 80 can be any suitable structure or element that cooperates with activation element 60. For example, arm 80 can move relative to receiver 30, in a controlled manner.

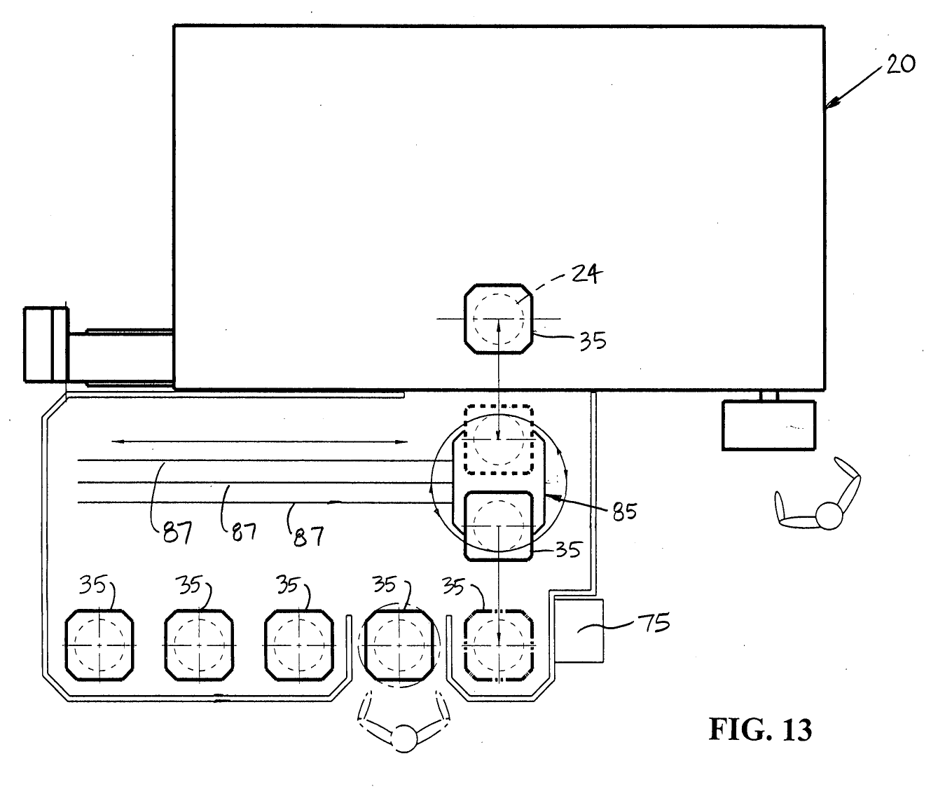

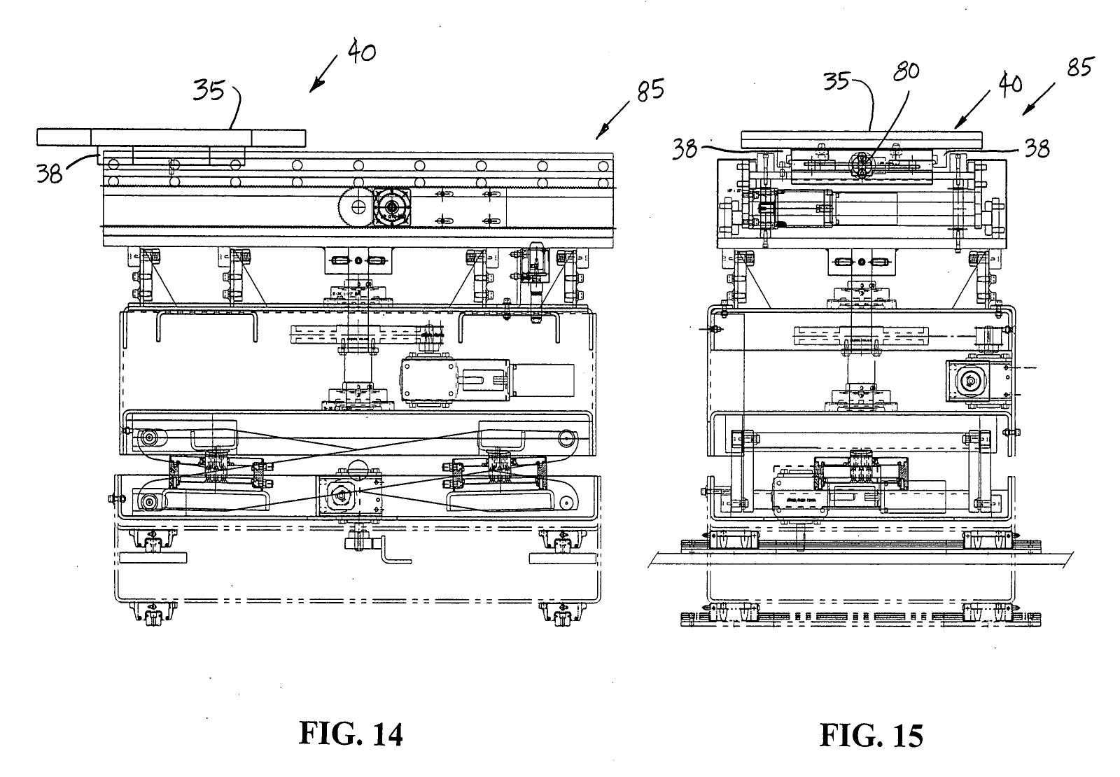

When in the disengaged position, robot 85 can be operated to lift, move and/or detach pallet 35 from or with respect to receiver 30. Robot 85 can move along track 87, such as shown in FIG. 13, to move or transport pallet 35. Robot 85 can also be programmed and/or controlled to not operate activation element 60 and thus to leave pallet 35 in the engaged position and mounted or fixed with respect to receiver 30.

As shown in FIGS. 2 and 5, pads 34 can be used to prevent frictional wear between pallet 35 and receiver 30. In certain embodiments of this invention, pneumatic air and/or a brush device can be used to clean or remove particles from pad 34, for example before engaging pallet 35 with receiver 30.

As shown in FIGS. 1-6, one or more pins 31 can be used to locate and/or fix a position of pallet 35 with respect to receiver 30.

In one embodiment of the method for attaching and detaching pallets 35 with respect to frame 25 of 5-axis machine 20, an active pallet 35 is automatically detached from frame 25. Robot 85 and/or controller 75 are programmed and/or used to move the detached active pallet 35 to storage facility 70. Robot 85 and/or controller 75 then move an idle or inactive pallet 35 from storage facility 70 and automatically attach the inactive pallet 35 to frame 25.

Controller 75 can be programmed to operate robot 85 in any suitable manner required to attach or detach pallet 35 with respect to receiver 30. A controller of 5-axis machine 20 can send a control signal or other control information to robot 85 and/or controller 75. For example, robot 85 and/or controller 75 can receive a set of instructions for moving each active and/or inactive pallet 35.

In certain embodiments according to this invention, robot 85 operates or moves at least one rail 38 or other suitable structural element used to attach or detach pallet 35 with respect to receiver 30.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

What is claimed is:

1. In a 5-axis machining center having a frame that accommodates a receiver, the improvement comprising: a pallet detachably attached with respect to the frame, and an automated pallet changer one of attaching and detaching the pallet with respect to the frame.

2. In the 5-axis machining center according to claim 1, wherein the automated pallet changer comprises a base fixed with respect to the frame, and the pallet engageable with the base.

3. In the 5-axis machining center according to claim 2, wherein in an engaged position the pallet is locked with respect to the base.

4. In the 5-axis machining center according to claim 3, wherein the automated pallet changer comprises a keeper movable with respect to the base, and in the engaged position the keeper interferes with at least a portion of the pallet.

5. In the 5-axis machining center according to claim 1, wherein the automated pallet changer comprises a keeper movable with respect to the base between an engaged position and a disengaged position.

6. In the 5-axis machining center according to claim 5, wherein in the engaged position the keeper interferes with at least a portion of the pallet and in the disengaged position the automated pallet changer prevents the keeper from interfering with the pallet.

7. In the 5-axis machining center according to claim 5, wherein an edge portion of the keeper extends beyond a surface of the base.

8. In the 5-axis machining center according to claim 7, wherein in the engaged position the edge portion abuts a contact surface of the pallet.

9. In the 5-axis machining center according to claim 5, further comprising a bias element normally urging the keeper into the engaged position.

10. In the 5-axis machining center according to claim 9, wherein an activation element operates the bias element between the engaged position and the disengaged position.

11. In the 5-axis machining center according to claim 10, wherein the activation element comprises a pushrod moveable between the engaged position and the disengaged position.

12. In the 5-axis machining center according to claim 11, wherein in the disengaged position the pushrod contacts a clevis movably mounted with respect to the base.

13. In the 5-axis machining center according to claim 12, wherein a lever arm is operatively connected to the bias element and the keeper.

14. In the 5-axis machining center according to claim 10, wherein the activation element is mounted with respect to a rail movably mounted to engage with and move the pallet with respect to the frame.

15. An automated pallet changer for attaching and detaching a pallet of a 5-axis machining center, comprising: a base fixed with respect to a frame, a keeper moveable with respect to the base, and an activation element operating the keeper between an engaged position and a disengaged position.

16. The automated pallet changer according to claim 15, wherein in the engaged position the keeper interferes with at least a portion of the pallet.

17. The automated pallet changer according to claim 15, wherein a bias element normally urges the keeper into the engaged position.

18. The automated pallet changer according to claim 15, wherein a lever arm is operatively connected between the activation element and the keeper.

19. A method for attaching and detaching pallets with respect to a frame of a 5-axis machining center, the method comprising: automatically detaching an active pallet of the pallets from the frame; moving the detached active pallet to a storage facility; moving an inactive pallet of the pallets from the storage facility; and automatically attaching the inactive pallet to the frame.

20. The method according to claim 19, wherein a pallet changer is automatically operated to one of attach and detach at least one of the pallets with respect to the frame.

21. The method according to claim 20, wherein an actuation element is operated to move a keeper between an engaged position and a disengaged position.

22. The method according to claim 20, wherein a controller emits a signal received by the pallet changer, and the signal contains operation information.
